(19) United States
(12) Patent Application Publication
(10) Pub. No.: US 2008/0310667 A1
(43) Pub. Date: Dec. 18, 2008

(54) Earphone for playing background sounds

(75) Inventors: Ming-Hui Lin, Taipei (TW); Vam Chang, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/808,615

(22) Filed: Jun. 12, 2007

(51) Int. Cl. H04R 25/00

(52) U.S. Cl. 381/384

(57) ABSTRACT

The present invention is to provide an earphone for playing external background sounds which comprises a background audio module and a speaker, wherein said earphone may be connected to portable electronic devices and outputs audio signals such as voice, music, or radio received from the electronic devices through the speaker. Said earphone is able to acquire the external background sounds through background audio module and outputs the acquired background sounds along with the audio signals through the speaker. Thereby, user can still hear the external background sounds through the speaker while talking on a phone or listening to audio signals like music or radio.

### BACKGROUND OF THE INVENTION

The present invention relates to an earphone, more particularly to an earphone for playing external background sounds. In other words, the earphone can output sound signal from a portable electronic device itself as well as background sounds from outside, whose volume level is adjustable.

### BACKGROUND OF THE INVENTION

Because of the mature audio compression technology in the electronic industry, MP3 audio players are massively produced and then become one of the most popular electronic devices. Therefore, manufacturers believe the prospects of the audio players and start to devote themselves to the research and development thereof. In the places such as streets, buses, subways and the like, there are people often wearing earphones and enjoy listening to music. Besides, manufacturers have researched and developed all kinds of earphones such as the one with fully covered earcups, half-covered earcups and in-the-ear design, and the idea behind these designs is to fully present the essence of the music. For example, earphones with the in-the-ear design as commonly called earbuds are able to block the noises resulting from listing environment, so thus users solely can hear music played by the audio player. However, using the exampled earphones as mentioned above without being able to hear background sounds of the listening environment would put users' safety in risk so that users would then possibly miss the important timing to prevent the accidents from happening.

### SUMMARY OF THE INVENTION

Due to the risk that when using the conventional earphones, users would be in danger for being unable to make timely reaction because of missing external background sounds like other people's warning, horning or broadcast, the inventor has developed an earphone for playing external background sounds based on expertise and years of experience in order to solve this problem.

The present invention is to provide an earphone for playing external background sounds. The earphone comprises a background audio module and a speaker, wherein the earphone may be connected to portable electronic devices and outputs audio signals such as voice, music, or radio from the electronic devices through the speaker. The background audio module is able to acquire the external background sounds and the earphone outputs the acquired background sounds through the speaker. Thereby, the external background sounds may be acquired via the background audio module and users can still hear the external background sounds through the speaker while talking on the phone or listening to audio signals like music or radio.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a three-dimensional graph of the earphone of a preferred embodiment of the present invention; and

FIG. 2 is a circuit diagram of the earphone of a preferred embodiment of the present invention.

### DETAILED DESCRIPTION OF THE PREFERRED EMBODIMENT

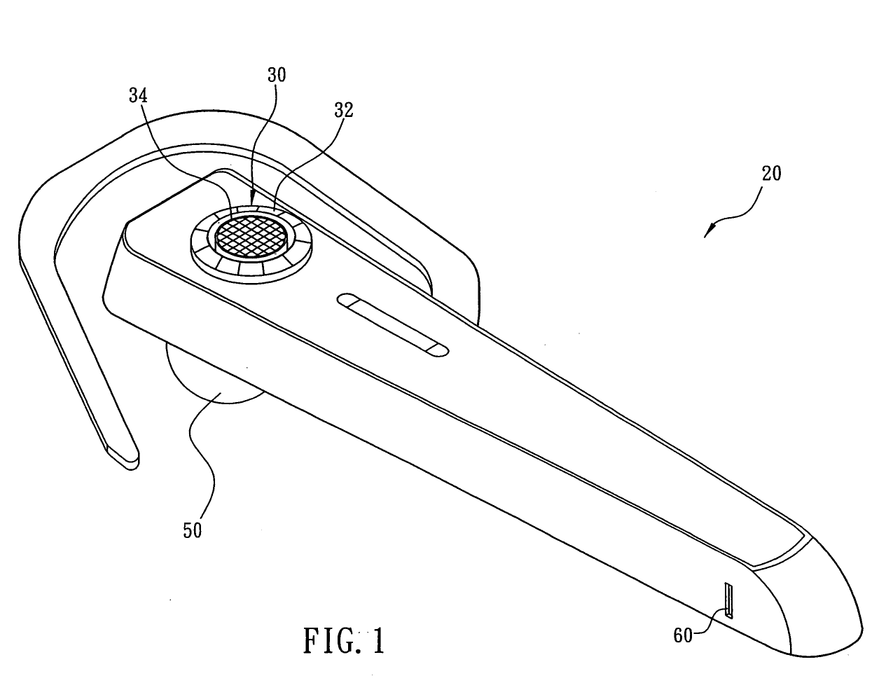

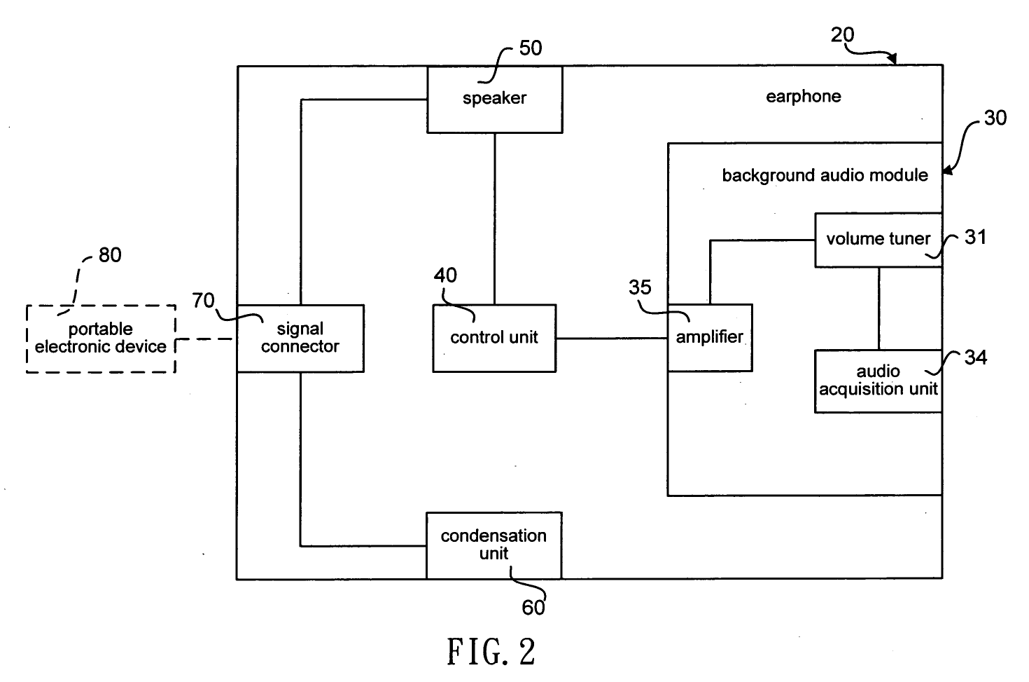

Please refer to FIGS. 1 and 2, the present invention is an earphone for playing external background sounds. The earphone 20 (such as a Bluetooth wireless earphone or a double-earcup earphone) comprises a control unit 40 (such as an audio decoder), a signal connector 70 (such as an earphone jack or a Bluetooth acquisition module), a background audio module 30 and at least a speaker 50, wherein the speaker 50 and the signal connector 70 are installed on the earphone 20 and connected to each other. Besides, the signal connector 70 may communicate with a portable electronic device 80 (such as a MP3 player or mobile phone) wiredly or wirelessly, receive the first audio signals (such as voice, music or radio) from the portable electronic device 80 and transfer the first audio signals to speaker 50 for output.

The background audio module 30 comprises an audio acquisition unit 34 and a volume tuner 31. Said audio acquisition unit 34 is installed on the earphone 20 and may be an Omni-directional microphone. Also, the audio acquisition unit 34 is connected with the volume tuner 31 and will be driven by the volume tuner 31 to acquire the external background sounds of the listening environment when the volume tuner 31 of the background audio module 30 is enabled, wherein the users may adjust the volume of the external background sounds.

The control unit 40 connects with the background audio module 30 and the speaker 50 respectively. When the external background sounds are acquired, the audio acquisition unit 34 first converts the external background sounds into voltage signals and transfers the voltage signals to the control unit 40. The control unit 40 then converts the voltage signals into digital signals. Through two times of conversion, the second audio signals are transferred to the speaker 50. Thus, the earphone can output the acquired background sounds and audio signals through the speaker 50 simultaneously. Thereby, after the background audio module 30 acquires the external background sounds, the users can still hear the external background sounds such as broadcast, horning and warning through the speaker 50 while talking on the phone or listening to the music or radio, which prevents from being unable to make timely reaction or missing important messages.

Please refer to FIGS. 1 and 2, in one embodiment of the present invention, the background audio module 30 further comprises an amplifier 35 connected with the volume tuner 31 whose level of adjustment is corresponding to the volume of the external background sounds after the volume tuner 31 is enabled.

The volume tuner 31 may be designed as a disk 32 that revolvingly pivoted on top of the earphone 20. While the disk 32 is revolved, the background audio module 30 will start to drive the audio acquisition unit 34 to acquire the external background sounds. Said disk 32 may be revolved from one side of the earphone 20 to another, and the amplifier 35 will increase the volume of the external background sounds correspondingly according to the level of revolution of the disk 32. On the contrary, while the disk 32 is revolved back to another side, the background audio module 30 will stop the audio acquisition unit 34 from acquiring the external background sounds.

Furthermore, please refer to FIGS. 1 and 2, in one embodiment of the present invention, the earphone 20 further comprises a condensation unit 60 which may be a high-directional microphone. Said condensation unit 60 is connected with the signal connector 70 and capable of converting the external background sounds into voltage signals after receipt so that the signal connector 70 may transfer the voltage signals to the portable electronic device 80.

While the invention herein disclosed has been described by means of specific embodiments, numerous modifications and variations could be made thereto by those skilled in the art without departing from the scope and spirit of the invention set forth in the claims.

What is claimed is:

1. An earphone for playing background sounds, comprising:
at least a speaker for outputting audio signal;
a signal connector connected with said speaker for connecting to an external portable electronic device and transferring first audio signals from said portable electronic device to said speaker;
a background audio module comprising an audio acquisition unit and a volume tuner, wherein said audio acquisition unit is connected with said volume tuner for acquiring external background sounds through said earphone, and said volume tuner is utilized to drive said audio acquisition unit and adjust the volume of said background sounds, and
a control unit connected with said background audio module and said speaker respectively for converting said background sounds into second audio signals and transferring said second audio signals to said speaker.

2. An earphone for playing background sounds of claim 1, wherein said background audio module further comprises an amplifier connected with said volume tuner whose level of adjustment is corresponding to the volume of said background sounds after said volume tuner is enabled.

3. An earphone for playing background sounds of claim 2, wherein said volume tuner is designed as a disk revolvingly pivoted to said earphone.

4. An earphone for playing background sounds of claim 3, wherein said background audio module starts to drive said audio acquisition unit to acquire external background sounds while said disk is revolved, and stops while said disk is revolved back to another side.

5. An earphone for playing background sounds of claim 4, wherein said audio acquisition unit is an Omni-directional microphone.

6. An earphone for playing background sounds of claim 4, wherein said earphone further comprises a condensation unit connected with said signal connector for acquiring sounds.

7. An earphone for playing background sounds of claim 6, wherein said condensation unit is a high-directional microphone.

8. An earphone for playing background sounds of claim 4, wherein said signal connector is a bluetooth acquisition module.

9. An earphone for playing background sounds of claim 4, wherein said control unit is an audio decoder.
